(19) United States
(12) Patent Application Publication
(10) Pub. No.: US 2026/0177773 A1
(43) Pub. Date: Jun. 25, 2026

(54) All dry-type ribbon optical cable and method of making the same

(71) Applicant: SUMEC MACHINERY AND ELECTRONIC CO., LTD., Nanjing (CN)

(72) Inventors: Xubo Ye, Nanjing (CN); Chao Chen, Nanjing (CN); Xuewu ZOU, Nanjing (CN); Renchun ZHANG, Nanjing (CN)

(73) Assignee: SUMEC MACHINERY AND ELECTRONIC CO., LTD., Nanjing (CN)

(21) Appl. No.: 19/424,820

(22) Filed: Dec. 18, 2025

(30) Foreign Application Priority Data
Dec. 20, 2024 (CN) 2024231495866
Nov. 19, 2025 (CN) 2025117045563

(51) Int. Cl. G02B 6/44

(52) U.S. Cl. CPC G02B 6/448; G02B 6/4432; G02B 6/4435; G02B 6/4485

(57) ABSTRACT

The present invention describes an all dry-type ribbon optical cable and its manufacturing method. The ribbon optical fibers are wrapped using a loose tube, with the tube closely surrounding the fibers as much as possible to increase the fiber-to-space ratio, thereby enhancing the structural cost-efficiency. Additionally, dry-type water-blocking materials are used both inside and outside the loose tube, eliminating the use of grease. This environmentally friendly design improves the fiber-to-space ratio within the loose tube while significantly enhancing the ease of installation. The sheath is designed with air-guiding grooves, enabling air-blown installation of the optical cable. This reduces labor requirements, speeds up installation, and minimizes attenuation caused during deployment. During the manufacturing process, the ribbon optical fibers and the first dry type water-blocking components enter the loose tube in a wavy pattern during extrusion.

### TECHNICAL FIELD

The present application relates to optical fiber cable, specifically to all dry-type of ribbon optical cable and method of making the same.

### BACKGROUND

Ribbon optical cables are highly favored in backbone network applications due to their high fiber count, dense fiber packing, and ease of installation. However, conventional ribbon cables face several challenges. On one hand, traditional ribbon cable structures employ oil-filled waterproofing, which requires significant amounts of grease. This grease, a chemically harmful substance, forces technicians to spend approximately one hour per cable using large quantities of alcohol and wipes to remove it during splicing—a process that is time-consuming, labor-intensive, and material-wasteful. Additionally, traditional ribbon cables tend to have oversized dimensions, low fiber density, and poor structural economy.

### SUMMARY OF THE INVENTION

Embodiments of this application provide an all dry-type ribbon optical cable to address the issues in existing ribbon cables, such as time-consuming, labor-intensive, and environmentally unfriendly grease usage, as well as low fiber density.

On a first aspect of the present invention, an all dry-type ribbon optical cable is disclosed and described. Said all dry-type of ribbon optical cable comprises:
a loose tube, enclosing ribbon optical fibers and a first dry-type water-blocking component, wherein a volume of the ribbon optical fibers occupies more than 70% and ≤95% of the loose tube's internal space;
a wrapping tape, enveloping an exterior of the loose tube, with a second dry-type water-blocking component disposed between the wrapping tape and the loose tube;
a protective sheath, enclosing the wrapping tape, the outer wall of the protective sheath features ventilation grooves composed of alternating peaks and valleys, with a height difference between the highest peak and lowest valley of 0.02 mm-1 mm.

Further, the loose tube is made of a flexible thermoplastic material with a wall thickness of 0.1 mm-0.5 mm.

Additionally, the material of the loose tube is one of PVC, TPU, LSZH, and TPEE, or a combination of them.

Further, each ribbon optical fiber has dimensions of width 3.0 mm-3.3 mm and thickness 0.30 mm-0.36 mm.

Additionally, multiple ribbon optical fibers are stacked orderly along the thickness direction of each ribbon optical fibers.

Moreover, the all dry-type optical fiber cable includes 12 ribbon optical fibers, each comprising a 12-core fiber ribbon.

Further, the first and second dry-type water-blocking components are made of water-blocking powder or water-blocking yarn.

Additionally, the first dry-type water-blocking component has a swelling rate ≥70 ml/g/min, and the second dry-type water-blocking component has a swelling rate ≥65 ml/g/min.

Moreover, tensile strength members are embedded in the sidewalls of the protective sheath and arranged in an array around the cable's central axis.

On a second aspect of the present invention, a method for preparing the all dry-type ribbon optical cable is described and disclosed. The preparation method comprises encapsulating the ribbon optical fibers with the loose tube via an extrusion process. During extrusion, the ribbon fibers and first dry-type water-blocking component enter the loose tube in an undulating motion, with the ribbon fibers contacting the inner wall of the loose tube. The undulation has a spatial period of 120 mm-180 mm, undulation period, and an amplitude of 65%-90% of the loose tube's inner diameter during extrusion.

Further, upstream of the direction in which the ribbon fiber moves toward the loose tube, a perturbation is applied to the ribbon fiber to induce an undulating motion propagating from upstream to downstream.

Additionally, during loose tube formation, two separate streams of compressed gas are introduced intermittently into the loose tube. The interval between gas pulses on the same path is a multiple of the undulation period of the ribbon fibers. One gas stream is half a spatial period ahead of the other, with one stream contacting one side of the ribbon fibers and the other stream contacting the opposite side of the ribbon fibers.

After extruding the protective sheath over the loose tube and wrapping tape, the ribbon optical cable undergoes negative pressure shaping. A uniform clamping force of 20N-100N is applied circumferentially at the entrance of the negative pressure shaping device to guide the ribbon optical cable into the negative pressure shaping device.

The clamping force is applied via a clamping collar mounted at the negative pressure shaping device entrance.

The clamping collar's inner ring is fitted with a sealing sleeve, whose inner wall has a smooth circular profile or a corrugated structure matching the peaks and valleys of the protective sheath.

### BENEFICIAL EFFECTS

The invention provides an all dry-type ribbon optical cable and its preparation method. By encapsulating ribbon fibers with a loose tube and maximizing fiber space occupancy, structural economy is enhanced. The use of dry-type water-blocking components eliminates grease, ensuring environmental friendliness and improved installation efficiency. The ventilation grooves on the protective sheath enable gas-assisted cable laying, reducing labor, accelerating deployment, and minimizing attenuation. During preparation, the undulating motion of the ribbon fibers, combined with gas streams, allows compact placement within the loose tube while minimizing stress and attenuation. The uniform clamping force during negative pressure shaping ensures high circularity of the final ribbon optical cable.

### DESCRIPTION OF THE DRAWINGS

The drawings that constitute a part of this application are provided to further illustrate this application. The schematic embodiments and their descriptions are used to explain this application and do not constitute improper limitations on it. In the drawings:

FIG. 1 is a cross-sectional schematic diagram of an embodiment of the all dry-type ribbon optical cable of the present invention.

FIG. 2 is a schematic diagram of the undulation period of the all dry-type ribbon optical cable in an embodiment of the present invention.

FIG. 3 is a structural schematic diagram of the loose tube forming equipment in an embodiment of the present invention.

FIG. 4 is a partial schematic diagram of the loose tube forming equipment in an embodiment of the present invention.

FIG. 5 is a schematic structural diagram of the entrance of the negative pressure shaping device in an embodiment of the present invention.

FIG. 6 is a graph showing the relationship between the clamping force of the clamping collar at the entrance of the negative pressure shaping device and the internal pressure of the negative pressure shaping device in an embodiment of the present invention.

FIG. 7 is a graph showing the relationship between the clamping force of the clamping collar at the entrance of the negative pressure shaping device and the roundness of the optical cable in an embodiment of the present invention.

The meanings of the reference numerals in the figures are as follows:

1—Protective sheath; 2—Wrapping tape; 3—Loose tube; 4—Ribbon optical fibers; 5—Tensile strength members; 6—First dry-type water-blocking component; 7—Ventilation grooves; 8—Second dry-type water-blocking component; 9—Switch; 10—Clamping collar; 11 Sealing sleeve; 100—Extrusion head; 101—Ventilation hole; 1011—First ventilation hole; 1012—Second ventilation hole; 10111—First ventilation hole outlet; 10121—Second ventilation hole outlet; 200—Mold core; 201—Mold core through-hole; 210—Insertion section; 220—First tapered section; 230—First cylindrical section; 300—Mold sleeve; 310—Second tapered section; 320—Second cylindrical section; 400—Inflation base; 410—Inflation inlet; 411—First gas supply hole; 420—Second gas supply hole; 430—Positioning pin; 440—Sealing gasket; 450—Annular sealing protrusion; 460—Insertion part; 500—Optical fiber guiding mechanism; 510—Needle tube seat; 511—Bolt; 512—Guiding through-hole; 513—Connection section; 514—Guiding section; 502—Guiding assembly; 600—Forming space; 610—Tapered space; 620—Cylindrical space; 630—Exit end; 700—Pressure ring

### DETAILED DESCRIPTION OF THE EMBODIMENTS

It should be noted that, where there is no conflict, features of different embodiments in this application can be combined. Below, this application is described in detail with reference to the drawings and specific embodiments.

In this description, terms such as “center,” “longitudinal,” “transverse,” “length,” “width,” “thickness,” “top,” “bottom,” “front,” “rear,” “left,” “right,” “vertical,” “horizontal,” “clockwise,” and “counterclockwise” are used only for ease of explanation and simplification of the description. These do not indicate or imply that the devices or components must be constructed or operated in a specific orientation. Thus, they should not be understood as limitations on this application. Additionally, the terms “first” and “second” are used merely for descriptive purposes and should not be construed as implying relative importance or the quantity of the designated technical features.

In this description, unless otherwise explicitly defined, terms such as “installation,” “connection,” and “coupling” should be understood broadly. For example, they can refer to fixed or detachable connections, integral connections, mechanical or electrical connections, direct or indirect connections via intermediaries, or interactions between components. The specific meaning of these terms should be understood based on the particular context of this application.

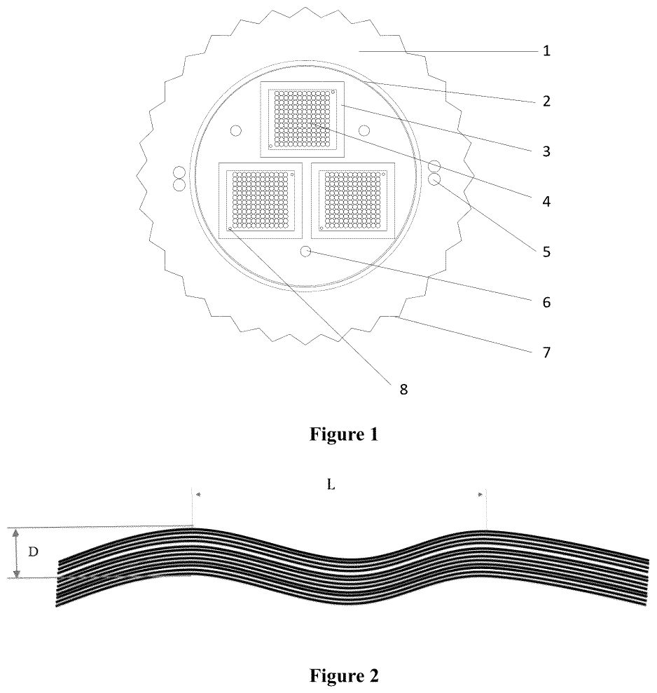

As shown in FIG. 1, one embodiment of the all dry-type ribbon optical cable comprises a loose tube (3), wrapping tape (2) and protective sheath (1).

The loose tube (3) encloses ribbon optical fibers (4) and a first dry-type water-blocking component (8), wherein the ribbon optical fibers (4) occupy more than 70% and up to 95% of the internal volume of the loose tube (3).

The wrapping tape (2) envelopes the exterior of the loose tube (3), with a second dry-type water-blocking component (6) positioned between the wrapping tape (2) and the loose tube (3). The wrapping tape (2) is typically made of a water-blocking tape, non-woven fabric, or other suitable plastic film, serving to prevent water infiltration and maintain cable core stability.

The protective sheath (1) encloses the wrapping tape (2). The protective sheath (1) can be made of PE, flame-retardant PE, or LSZH. When using flame-retardant PE or LSZH, the optical cable exhibits flame-retardant properties. The outer wall of the protective sheath (1) features ventilation grooves (7), formed by alternating peaks and valleys, where the height difference between the highest peak and the lowest valley ranges from 0.02 mm to 1 mm.

In this embodiment, the all dry-type ribbon optical cable replaces grease-based water-blocking materials with dry-type water-blocking components, allowing the loose tube (3) to conform as closely as possible to the ribbon optical fibers (4). This results in a ribbon optical fiber occupancy of 70%-95% by volume within the loose tube (3). This design improves structural compactness and enhances the economic efficiency of the optical cable while eliminating the inconvenience and environmental concerns associated with grease-based materials.

The protective sheath (1), featuring ventilation grooves (7), allows for air-blown installation of the optical cable, reducing labor requirements, enabling rapid deployment, and minimizing installation-induced attenuation.

In some preferred embodiments, the loose tube (3) is configured to be as lightweight and compact as possible while still enclosing the ribbon optical fibers (4) and first dry-type water-blocking component (8). Therefore, the loose tube (3) is preferably made of flexible materials with a thin wall thickness, such as thermoplastic materials with good elasticity and excellent processability, and a wall thickness ranging from 0.1 mm to 0.5 mm.

In some preferred embodiments, the loose tube (3) is made from one or a combination of PVC, TPU, LSZH, and TPEE.

In some preferred embodiments, multiple ribbon optical fibers (4) are stacked in the thickness direction in an orderly manner.

As illustrated in FIG. 1, each loose tube (3) comprises twelve ribbon optical fibers (4), each comprising a 12-core fiber ribbon. Further, each loose tube (3) consists of twelve ribbon optical fibers (4), each comprising a 12-core fiber ribbon. The dimensions of each ribbon optical fiber (4) are 3.0 mm-3.3 mm in width and 0.30 mm-0.36 mm in thickness. Taking the vertical direction in FIG. 1 as the width of each ribbon fiber 4 and the horizontal direction as its thickness, each ribbon fiber 4 contains a 12-core array along its width direction. All twelve ribbon fibers 4 are aligned parallelly and orderly along the horizontal direction, ensuring that the 12-core arrays of adjacent ribbon fibers are precisely aligned in the width direction. Consequently, the cross-section of the ribbon fiber assembly forms a rectangular configuration. Accordingly, the loose tube 3 is designed with a rectangular cavity to optimally encapsulate the ribbon fibers 4. In this embodiment, the ribbon fibers 4 are neatly stacked into a rectangular arrangement, and the flexible material of the loose tube 3 is wrapped around the periphery of the fiber assembly. By precisely controlling the dimensions of the loose tube 3 to ensure it tightly conforms to the outer profile of the ribbon fiber assembly, the fiber packing density can be effectively enhanced.

While the above embodiment discloses the implementation of such ribbon fibers 4, the present invention does not limit the number of ribbon fibers 4, the number of fiber cores per ribbon fiber 4, or the stacking configuration of ribbon fibers 4. For example, if the stacked ribbon fibers 4 collectively form a cross-section approximating a circular shape, the corresponding loose tube 3 can also be designed with a circular cavity to optimally encapsulate the ribbon fibers 4.

In the aforementioned embodiments, within each loose tube 3, since the volume of the first dry water-blocking component 8 is relatively small compared to the entire ribbon fiber assembly, the inner cavity shape of the loose tube 3 need only conform to the overall shape of the encapsulated ribbon fibers 4 to ensure tight adhesion between the loose tube 3 and the ribbon fibers 4. In some embodiments, regardless of the shape in which the ribbon fibers 4 are arranged, the loose tube 3 may initially be extruded with a circular cavity. After the loose tube 3 encapsulates the ribbon fibers 4 and undergoes cooling and shaping, the loose tube 3 contracts to form an inner cavity that adapts to the shape of the enclosed ribbon fibers 4.

In the aforementioned embodiments, the first dry water-blocking component 8 and the second dry water-blocking component 6 are made of water-blocking powder or water-blocking yarn. Common water-blocking powder materials include superabsorbent polymer (SAP), such as sodium polyacrylate. Water-blocking yarn typically comprises two parts: a reinforcement base material (e.g., nylon or polyester) providing tensile strength and elongation, and swelling fibers or powder containing polyacrylate. When water-blocking yarn is used, the linear density of a single strand does not exceed 1000D.

In the aforementioned embodiments, to effectively achieve water-blocking, the first dry water-blocking component 8 has a swelling rate of ≥70 ml/g/min, and the second dry water-blocking component 6 has a swelling rate of ≥65 ml/g/min.

In these embodiments, the dry water-blocking material inside the loose tube 3 is distributed around the ribbon fibers 4 without grease, significantly improving installation convenience.

In some embodiments, the all dry-type ribbon fiber optic cable further comprises tensile reinforcement components 5 embedded in the sidewalls of the sheath 1. Multiple tensile reinforcement components 5 are arrayed around the ribbon fiber optic cable's central axis. As shown in FIG. 1, the tensile reinforcement components 5 are symmetrically distributed at 180° intervals. In other embodiments, they may be arranged at 5°-30° intervals around the ribbon fiber optic cable's center. The tensile reinforcement components 5 may be made of fiber-reinforced plastic composite rods or tensile fibers. When using fiber-reinforced plastic composite rods, the outer diameter should not exceed 1.5 mm to ensure cable flexibility.

Embodiments of this application also provide a production process for the fully dry ribbon fiber optic cable described above, primarily involving loose tube forming, sheath forming, and shaping.

Loose Tube Forming comprises the following steps.

Step S101: Extrude loose tube material into a tubular loose tube 3 using a loose tube forming device.

Step S102: Inject compressed gas into the loose tube 3 during forming.

Step S103: Thread the ribbon fibers 4 into the cavity of the loose tube 3.

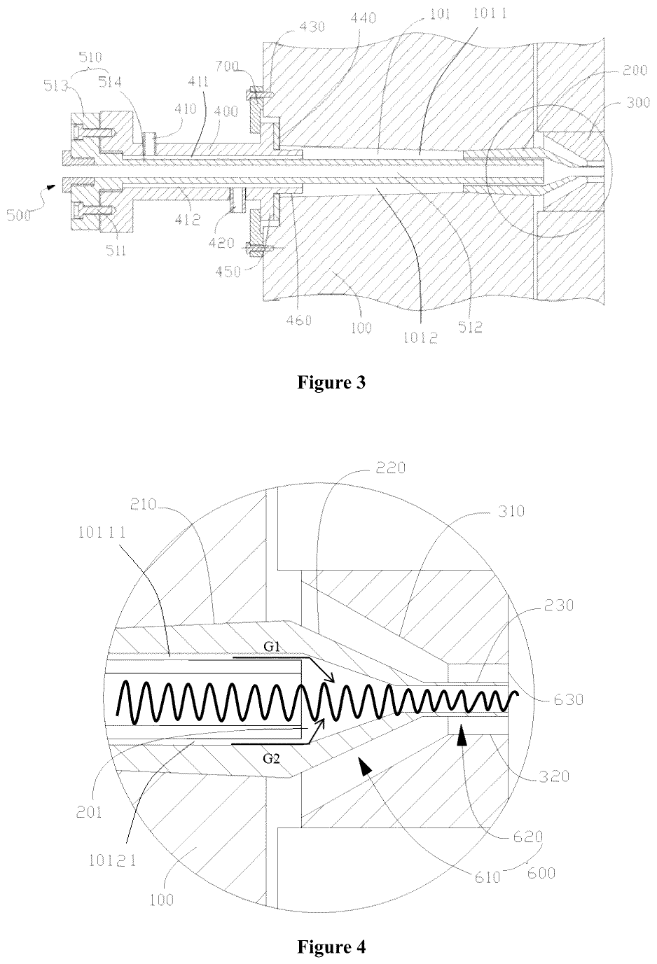

To achieve this process, the application provides a fully dry ribbon fiber optic cable loose tube forming device (FIG. 3), which ensures minimal optical loss when threading ribbon fibers 4 into narrow loose tubes 3.

As FIG. 3 shows, the present invention provides an all dry-type optical fiber cable. Said optical fiber cable comprises an extrusion head 100, a mold core (200) and a mold sleeve (300). The extrusion head (100) is provided with a ventilation hole (101) that extends through its length. The mold core (200) is connected to the extrusion head (100), with one end of the mold core (200) inserted into the ventilation hole (101) of the extrusion head (100), while the other end extends outward beyond the extrusion head (100). The mold core (200) is equipped with a mold core through-hole (201) that runs along its length, which is coaxial and in communication with the ventilation hole (101). The mold sleeve (300) is fitted around the outer circumference of the portion of the mold core (200) that extends out of the extrusion head (100). The inner wall of the mold sleeve (300) is annular, corresponding to the annular outer wall of the mold core (200). Between the inner wall of the mold sleeve (300) and the outer wall of the mold core (200), an annular forming space (600) is formed, which is in communication with the external environment.

During the manufacturing process, the extruded loose tube material from the extrusion machine enters the forming space (600) from its side. Since the extrusion head (100), mold core (200), and mold sleeve (300) remain relatively fixed, the shape and size of the forming space (600) also remain stable. Under the combined effect of the extrusion pressure applied by the extrusion head (100), mold core (200), mold sleeve (300), and the external feed pressure of the loose tube material, the material is extruded into a tubular shape, forming the loose tube (3). The formed loose tube (3) is extruded from the exit end (630) of the forming space (600), as shown in FIG. 3. The extruded loose tube (3) is then ready for subsequent processing steps. During the forming process, the inner cavity of the loose tube (3) remains in communication with the mold core through-hole (201). After compressed gas is introduced into the ventilation hole (101), it passes through the ventilation hole (101) and the mold core through-hole (201) into the inner cavity of the loose tube (3). This compressed gas supports the loose tube (3), ensuring that its outer diameter remains smooth and round, thereby improving the quality of the formed loose tube (3).

The mold core (200) comprises an insertion section (210), a first tapered section (220), and a first cylindrical section (230), which are connected sequentially. The insertion section (210) is connected to one end of the first tapered section (220), while the other end of the first tapered section (220) is connected to the first cylindrical section (230). The mold core through-hole (201) runs continuously through the insertion section (210), first tapered section (220), and first cylindrical section (230). The inner diameter of the first cylindrical section (230) is equal to the minimum inner diameter of the first tapered section (220).

The insertion section (210), first tapered section (220), and first cylindrical section (230) are integrally formed as a single structure, with the insertion section (210), first cylindrical section (230), and first tapered section (220) being coaxial. The first tapered section (220) corresponds to the central position of the forming space (600), while the end of the first cylindrical section (230) that is farthest from the first tapered section (220) is located at the exit end (630) of the forming space (600). During installation, the insertion section (210) is inserted into the ventilation hole (101) of the extrusion head (100), while the first tapered section (220) and first cylindrical section (230) extend beyond the ventilation hole (101).

The mold sleeve (300) comprises a second tapered section (310) and a second cylindrical section (320), which are integrally formed as a single structure. The second cylindrical section (320) is connected to the smaller-diameter end of the second tapered section (310), and the inner diameter of the second cylindrical section (320) is equal to the minimum inner diameter of the second tapered section (310).

During installation, the insertion section (210) is inserted into the ventilation hole (101) of the extrusion head (100). The second tapered section (310) is fitted around the outer circumference of the first tapered section (220), while the second cylindrical section (320) is fitted around the outer circumference of the first cylindrical section (230). At the same time, a gap is maintained between the first tapered section (220) and the second tapered section (310), and between the first cylindrical section (230) and the second cylindrical section (320). The spaces between the first tapered section (220) and the second tapered section (310), as well as between the first cylindrical section (230) and the second cylindrical section (320), are interconnected, thereby forming the forming space (600).

Please refer to FIG. 4. Optionally, the second tapered section (310) is positioned opposite the first tapered section (220), with a gap between the inner peripheral wall of the second tapered section (310) and the outer peripheral wall of the first tapered section (220), forming an annular tapered space (610). The taper angle of the second tapered section (310) is identical to that of the first tapered section (220). The second cylindrical section (320) is fitted around the outer circumference of the first cylindrical section (230), and is coaxially aligned with it. A gap is maintained between the inner peripheral wall of the second cylindrical section (320) and the inner peripheral wall of the first tapered section (220), forming a cylindrical space (620). The tapered space (610) and the cylindrical space (620) are interconnected to form the forming space (600).

During production, the loose tube material first enters the tapered space 610 of the forming space 600. Under external extrusion forces, the loose tube material moves to the right (as viewed in FIG. 3) and enters the cylindrical space 620. Finally, the material moves toward the exit end 630 of the forming space 600, exiting through it. As the loose tube material moves left to right, it envelops the mold core 200. Through the coordinated interaction of the mold core 200 and mold sleeve 300, a tubular loose tube 3 is formed and exits the right end of the forming space 600.

Since the mold core 200 comprises the first tapered section 220 and the mold sleeve 300 comprises the second tapered section 310, these tapered sections act as guides during extrusion. This guiding effect facilitates the smooth flow of the loose tube material from the tapered space 610 to the cylindrical space 620, ensuring precise alignment and stable shaping of the loose tube 3. The tapered geometry of the first tapered section 220 and second tapered section 310 gradually compresses and stabilizes the material flow, minimizing turbulence or uneven thickness while enhancing structural integrity. The transition from the tapered space 610 to the cylindrical space 620 optimizes pressure distribution, improving dimensional consistency and surface quality of the final loose tube 3.

The forming device further includes an inflation base 400 installed on the extrusion head 100. As shown in FIG. 3, the inflation base 400 is mounted to the left end of the extrusion head 100 via a positioning pin 430. The first end of the inflation base 400 is located inside the ventilation hole 101, while its second end is positioned outside the ventilation hole 101. A sealing gasket 440 is provided between the inflation base 400 and the extrusion head 100 to enhance sealing at their connection, reducing the risk of compressed gas leakage. The circumferential wall of the second end of the inflation base 400 is equipped with a first gas supply hole 410 and a second gas supply hole 420.

The inflation base 400 is a cylindrical structure. Its outer circumferential wall features an annular sealing protrusion 450, and it is provided with a first gas supply hole 411 and a second gas supply hole 412 along its length, both penetrating through the inflation base 400. The first gas supply hole 411 and second gas supply hole 412 are isolated from each other. The annular sealing protrusion 450 protrudes radially outward from the outer wall of the inflation base 400 along the radial direction of the first gas supply hole 411 and second gas supply hole 412. The inflation base 400 and annular sealing protrusion 450 may be integrally formed. The first gas supply hole 410 connects to the first gas supply hole 411, and the second gas supply hole 420 connects to the second gas supply hole 412. The inflation base 400 includes an insertion part 460 designed to fit into the ventilation hole 101. When the insertion part 460 is inserted into the ventilation hole 101, the first gas supply hole 411 and second gas supply hole 412 communicate with the ventilation hole 101.

The ends of the first gas supply hole 411 and second gas supply hole 412 away from the extrusion head 100 are sealed. The end face of the annular sealing protrusion 450 near the extrusion head 100 corresponds to the outer surface of the extrusion head 100. A sealing gasket 440 is placed between the annular sealing protrusion 450 and the extrusion head 100, which deforms under compression to ensure a seal at their connection.

The forming device also includes an optical fiber guiding mechanism 500, whose interior connects to the mold core through-hole 201. Optical fiber bundles, fiber ribbons, water-blocking yarns, or water-blocking tapes can enter the mold core through-hole 201 via the guiding mechanism. Since the mold core through-hole 201 communicates with the interior of the loose tube 3, these components can further advance into the loose tube 3 through the mold core through-hole 201.

The optical fiber guiding mechanism 500 comprises a needle tube seat 510, which is fixed to the extrusion head 100 via the inflation base 400. The needle tube seat 510 includes an integrally formed connection section 513 and guiding section 514. The gap between the inflation base 400 and the outer wall of the guiding section 514 forms passages for compressed gas, constituting the first gas supply hole 411 and second gas supply hole 412, which are circumferentially isolated around the guiding section 514. Similarly, the gap between the ventilation hole 101 and the outer wall of the guiding section 514 forms axially aligned passages for compressed gas, constituting the first ventilation hole 1011 and second ventilation hole 1012, which are also circumferentially isolated. The right end of the guiding section 514 is positioned within the mold core through-hole 201, aligning with the larger-diameter end of the first tapered section 220. The gap between the inner wall of the mold core 200 and the outer wall of the guiding section 514 forms axially arranged passages for compressed gas, constituting the first ventilation hole outlet 10111 and second ventilation hole outlet 10121, which remain circumferentially isolated. The first gas supply hole 411 connects to the first ventilation hole 1011 and first ventilation hole outlet 10111, while the second gas supply hole 412 connects to the second ventilation hole 1012 and second ventilation hole outlet 10121. Both first ventilation hole outlet 10111 and second ventilation hole outlet 10121 communicate with the first tapered section 220. The connection section 513 is mounted to the left end of the inflation base 400, sealing the left ends of the first gas supply hole 411 and second gas supply hole 412. The inner cavity of the guiding section 514 is an axially (through) hole, allowing optical fibers and water-blocking components to travel from the left end to the right end of the guiding section 514 (as viewed in the figure) and enter the first tapered section 220.

Optionally, the forming device further includes a pressure ring (700), which is fitted around the inflation base (400) and pressed against the side of the annular sealing protrusion (450) that is farthest from the insertion part (460). The pressure ring (700) is fixedly connected to the extrusion head (100).

By connecting the pressure ring (700) to the extrusion head (100), the inflation base (400) is indirectly secured to the extrusion head (100). This design ensures that no holes need to be created in the annular sealing protrusion (450) or the sealing gasket for connection with the extrusion head (100), thereby enhancing the sealing performance at the connection point between the annular sealing protrusion (450) and the extrusion head (100).

It should be noted that the pressure ring (700) can be fixed to the extrusion head (100) using a positioning pin, welding, or by bolt fastening.

During ventilation, one stream of compressed gas enters the first gas supply hole

(411) of the inflation base (400) through the first inflation inlet (410). The gas then sequentially passes through the first gas supply hole (411), first ventilation hole (1011), first ventilation hole outlet (10111), and the mold core through-hole (201) before entering the loose tube (3). Simultaneously, another stream of compressed gas enters the second gas supply hole (412) of the inflation base (400) through the second inflation inlet (420). This gas then sequentially flows through the second gas supply hole (412), second ventilation hole (1012), second ventilation hole outlet (10121), and the mold core through-hole (201), eventually reaching the loose tube (3). The compressed gas effectively supports the inner wall of the loose tube (3), ensuring that its outer wall remains smooth and round.

Using the aforementioned forming device, the optical fiber and water-blocking components can pass through the guiding section (514) and enter the first tapered section (220) of the mold core through-hole (201). Since the mold core through-hole (201) is in communication with the interior of the loose tube (3), the optical fiber and water-blocking components can continue to pass through the mold core through-hole (201) and enter the loose tube (3).

During the manufacturing process, compressed gas is continuously introduced into the inner cavity of the loose tube (3) during its extrusion molding process. The compressed gas provides internal support to the loose tube (3), ensuring that its outer diameter remains smooth and round. Additionally, this process allows the loose tube (3) to form an appropriate fiber excess length, ensuring optimal fiber transmission performance while maintaining a stable fiber excess length and achieving good attenuation characteristics.

In the embodiments of this application, the ribbon optical fibers (4) occupy a high proportion of the internal volume of the loose tube (3). As a result, guiding the ribbon optical fibers (4) into the loose tube (3) while ensuring ease of operation and fiber quality presents a challenge.

In certain preferred embodiments, when manufacturing the all dry-type ribbon optical cable shown in FIG. 1 using the aforementioned forming device, the ribbon optical fibers (4) and the first dry-type water-blocking component (8) enter the loose tube (3) during extrusion molding in a wave-like motion.

The ribbon optical fibers (4) and the first dry-type water-blocking component (8) are stacked in the configuration shown in FIG. 1. Upstream of the movement direction of the ribbon optical fibers (4) toward the loose tube (3), the equipment applies a perturbation at the input end of the optical fiber guiding mechanism (500) (i.e., the left end in FIG. 3) to the ribbon optical fibers (4) and the first dry-type water-blocking component (8).

As the ribbon optical fibers (4) and the first dry-type water-blocking component (8) move downstream toward the mold core through-hole (201), this perturbation generates wave-like oscillations, undulation, on them. By controlling the frequency and energy of the perturbation, different period distance and amplitudes of oscillations, undulation can be induced on the ribbon optical fibers (4) and the first dry-type water-blocking component (8).

As shown in FIG. 4, when the ribbon optical fibers (4) and the first dry-type water-blocking component (8) enter the first tapered section (220) and then the first cylindrical section (230), the mold cavity size decreases, which gradually reduces the amplitude of the ribbon optical fibers (4) and the first dry-type water-blocking component (8) due to mold constraints, leading to some energy loss. Additionally, as they continue to move deeper into the loose tube (3), friction and other factors further weaken the oscillations undulations.

In certain preferred embodiments, when the ribbon optical fibers (4) first come into contact with the inner wall of the loose tube (3), the wavelength of the oscillations on the ribbon optical fibers (4) ranges from 120 mm to 180 mm, and the amplitude is 65% to 90% of the inner diameter of the loose tube (3) during its extrusion molding process.

Under these conditions, once the ribbon optical fibers (4) enter the loose tube (3), and after the loose tube (3) cools and contracts, the ribbon optical fibers (4) occupy more than 70% and up to 95% of the internal volume of the loose tube (3).

The wave-like insertion method enables the ribbon optical fibers (4) to be accommodated within the loose tube (3) with minimal stress, ensuring a high fiber occupancy ratio while also minimizing fiber stress and attenuation.

In certain preferred embodiments, as shown in FIG. 4, to reduce energy loss of the ribbon optical fibers (4) and the first dry-type water-blocking component (8) when entering the first tapered section (220), first cylindrical section (230), and ultimately the loose tube (3), the forming process of the loose tube (3) can be optimized by controlling two separate streams of compressed gas entering the forming device.

Specifically, during the forming process of the loose tube (3), two streams of compressed gas are introduced at intermittent intervals. The interval frequency between consecutive gas pulses in the same stream is a multiple of the oscillation period of the ribbon optical fibers (4). Additionally, one gas stream is introduced half a wave period ahead of the other gas stream.

Before the ribbon optical fibers (4) enter the loose tube (3), one stream of gas contacts one side of the ribbon optical fibers (4), while the other gas stream contacts the opposite side.

As shown in FIG. 4, gas stream G1 enters the first tapered section (220) half a wave period earlier than gas stream G2. Under the combined effect of G1 and G2, the oscillations of the ribbon optical fibers (4) are reinforced.

Thus, multiple pulses of G1 gas enter the first tapered section (220) intermittently, and corresponding multiple pulses of G2 gas also enter intermittently. Each G1 gas pulse is half a wave period out of phase with its corresponding G2 gas pulse. The interval frequency between two consecutive G1 gas pulses and between two consecutive G2 gas pulses is precisely a multiple of the oscillation period of the ribbon optical fibers (4).

With this ventilation method, the oscillations or undulation can be reinforced while maintaining ventilation, allowing the wave-like motion to propagate deeper into the loose tube (3) along with the ribbon optical fibers (4) and the first dry-type water-blocking component (8).

This ensures that the ribbon optical fibers (4) are accommodated in a well-adapted position within the loose tube (3).

In certain preferred embodiments, the compressed gas used is nitrogen.

After completing the loose tube forming process, the protective sheath forming process must be carried out. The main method involves using an extrusion process to wrap the protective sheath (1) around the loose tube (3) and wrapping tape (2). This is followed by a shaping and setting process.

The present invention provides a shaping and setting method for the all dry-type ribbon optical cable, as shown in FIG. 1, which is performed as follows:
The optical cable is fed into the negative pressure shaping device, where the vacuum level is adjusted to ensure that the protective sheath (1) is rounded under vacuum pressure.

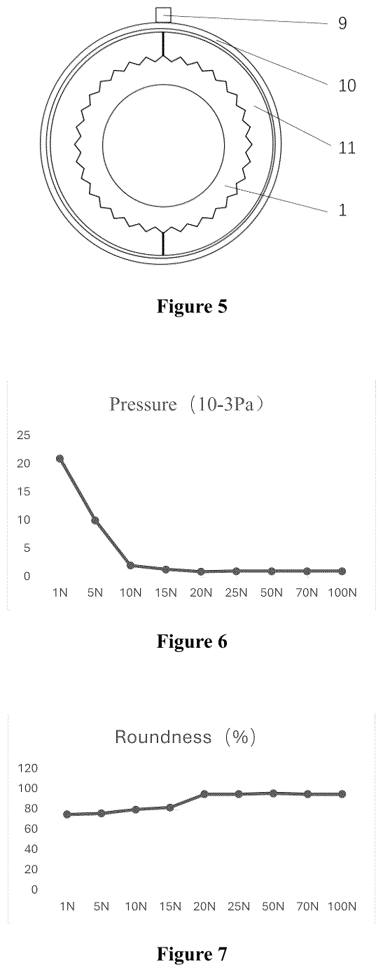

Since the outer wall of the protective sheath (1) in FIG. 1 features ventilation grooves (7), a clamping collar (10) is fixed at the entrance of the negative pressure shaping device, as shown in FIG. 5. The axial direction of the clamping collar (10) aligns with the entrance direction of the negative pressure shaping device.

The clamping collar (10) is annular and features a switch (9) on its circumference, which is equipped with a tension testing function. The clamping collar (10) allows the clamping force to be adjusted at the switch (9) to accommodate different ventilation groove (7) sizes.

The clamping collar (10) can be made of metal or rigid plastic, with a width of no less than 10 mm and a modulus of elasticity of no less than 50 GPa.

The inner ring of the clamping collar (10) is fitted with a sealing sleeve (11), which consists of two semi-circular segments made of different inner and outer materials.

The inner surface of the sealing sleeve (11) is smooth and shaped as either a circular ring or a profile matching the peaks and valleys of the protective sheath (1).

One side of the inner wall of the sealing sleeve (11) is made of flexible material with a strength of 2-5 MPa, allowing for full enclosure of the protective sheath (1) without air leakage while preventing scratches on the cable surface.

The outer wall of the sealing sleeve (11) is made of rigid plastic or metal, facilitating the secure attachment of the clamping collar (10).

The all dry-type ribbon optical cable passes through the sealing sleeve (11) before entering the negative pressure shaping device. Under the effect of clamping force, the sealing sleeve (11) compresses the all dry-type ribbon optical cable, ensuring that there are minimal gaps between the negative pressure shaping device and the all dry-type ribbon optical cable. Consequently, the presence of ventilation grooves (7) does not affect the vacuum level inside the negative pressure shaping device.

As shown in FIGS. 6 and 7, at the entrance of the negative pressure shaping device, a uniform clamping force of 20N-100N is applied circumferentially around the optical cable. Under this clamping force, the optical cable enters the negative pressure shaping device, where the internal environment is near vacuum and the optical cable achieves a well-rounded shape.

The above descriptions are merely example embodiments of this application and are not intended to limit the scope of the invention. For those skilled in the art, various modifications and variations can be made. Any modifications, equivalent replacements, or improvements made within the spirit and principles of this application should be considered within the scope of the claims.

1. An all dry-type ribbon optical cable, comprising:
a loose tube, enclosing ribbon optical fibers and a first dry-type water-blocking component, a volume of the ribbon fibers occupies more than 70% and less than or equal to 95% of an internal space volume of the loose tube;
a wrapping tape, wrapped around an exterior surface of the loose tube, with a second dry-type water-blocking component positioned between the wrapping tape and the loose tube; and
a sheath, wrapped around an exterior surface of the wrapping tape, with air-guiding grooves on an outer surface of the sheath; and the air-guiding grooves are formed by alternating peaks and valleys, with a height difference between a highest point of the peaks and a lowest point of the valleys ranging from 0.02 mm to 1 mm.

2. The all dry-type ribbon optical cable of claim 1, wherein the loose tube is made of a flexible thermoplastic material with a wall thickness ranging from 0.1 mm to 0.5 mm.

3. The all dry-type ribbon optical cable of claim 1, wherein the material of the loose tube comprises one or a combination of PVC, TPU, LSZH, or TPEE.

4. The all dry-type ribbon optical cable of claim 1, wherein each ribbon optical fiber has dimensions of a width of 3.0 mm to 3.3 mm and a thickness of 0.30 mm to 0.36 mm.

5. The all dry-type ribbon optical cable of claim 1, wherein ribbon optical cable is made of a plurality of ribbon optical fibers, and the ribbon optical fibers are neatly stacked in the thickness direction.

6. The all dry-type ribbon optical cable of claim 1, wherein a total number of a plurality of ribbon optical fibers is 12, and each of the plurality of the ribbon optical fiber further includes 12 cores.

7. The all dry-type ribbon optical cable of claim 1, wherein the first dry-type water-blocking component and the second dry-type water-blocking component are made of water-blocking powder or water-blocking yarn.

8. The all dry-type ribbon optical cable of claim 1, wherein the first dry-type water-blocking component has an expansion rate of at least 70 ml/g/min, and the second dry-type water-blocking component has an expansion rate of at least 65 ml/g/min.

9. The all dry-type ribbon optical cable of claim 1, further comprising tensile members embedded within the side wall of the sheath, wherein multiple tensile members are arranged in an array around a center of the ribbon optical cable.

10. A method for manufacturing the ribbon optical cable of claim 1, comprising:
utilizing an extrusion process to encase ribbon optical fibers with a loose tube, wherein
the ribbon optical fibers and a first dry-type water-blocking component are introduced into the loose tube in a wave-like manner during the extrusion process;
wherein, as the ribbon optical fibers begin to contact an inner wall of the loose tube, a wavelength of a wave on the ribbon optical fibers is between 120 mm and 180 mm, and an amplitude of the wave is 65%-90% of the loose tube's inner diameter during the extrusion process.

11. The method of claim 10, wherein disturbances are applied upstream of the movement direction of the ribbon optical fibers toward the loose tube, causing the ribbon optical fibers to form waves as they move downstream.

12. The method of claim 11, wherein during the formation of the loose tube, two streams of compressed gas are introduced into the loose tube intermittently, and the interval frequency between two adjacent gas streams in a same gas path is a multiple of the wavelength period of the wave on the ribbon optical fibers, with one gas stream entering half a period faster than the other; one stream contacts one side of the ribbon optical fibers, while the other stream contacts an opposite side of the ribbon optical fibers.

13. The method according to claim 12, wherein after the extrusion of the sheath over the loose tube and wrapping layer, the optical cable undergoes vacuum shaping by applying a uniform clamping force of 20N to 100N around the optical cable at an entrance of the vacuum shaping equipment and directing the optical cable into the vacuum shaping equipment under the uniform clamping force.

14. The method according to claim 13, wherein the uniform clamping force around the optical cable at the entrance of the vacuum shaping equipment is applied using a clamping collar installed at the entrance.

15. The method according to claim 14, wherein inner wall of the clamping collar is smooth and shaped either as a circular ring or with a profile matching the peaks and valleys of the sheath.
